(19) United States
(12) Patent Application Publication
(10) Pub. No.: US 2016/0345488 A1
(43) Pub. Date: Dec. 1, 2016

(54) Spreader Attachment

(71) Applicant: James Lee Douglas Reitzel, Edon, OH (US)

(72) Inventor: James Lee Douglas Reitzel, Edon, OH (US)

(21) Appl. No.: 15/236,819

(22) Filed: Aug. 15, 2016

Related U.S. Application Data
(63) Continuation-in-part of application No. 14/064,743, filed on Oct. 28, 2013.

(51) Int. Cl. A01C 15/04; A01C 7/02; F04D 29/42; A01C 15/02; F04D 25/08; F04D 29/28

(52) U.S. Cl. CPC A01C 15/04; F04D 25/08; F04D 29/282; F04D 29/4206; A01C 15/02; A01C 7/02

(57) ABSTRACT

A dry particulate spreader includes an attachment assembly for use with a portable hand-held air blower for entraining granular fertilizer, grass seed or similar materials into the discharge air stream of the blower, whereby the particulate is broadcast by the air stream. The attachment assembly comprises an adapter secured to the outlet tube of the air blower which penetrates the outlet tube and introduces a semi-cylindrical nozzle into the air stream. The downstream side of the nozzle is open to the air stream and to the particulate hopper. The air flow around the nozzle creates a low pressure area on the open side of the nozzle. The low pressure induces the particulate contained in a hopper attached to the adapter to enter the air stream. An adjustable valve is provided between the hopper and the nozzle to regulate particulate flow. The adapter is located near the end of the outlet tube of the air blower so the particulate is well mixed in the air stream before exiting the outlet tube.

### CROSS REFERENCE TO RELATED APPLICATIONS

Ser. No. 14/064,743

### SPECIFICATION

### Background of the Invention

### Description of Prior Art

The prior art includes several patents related to devices for dispensing particulates and grass seeds and fertilizers. U.S. Pat. No. 6,409,097 to McCauley (2002) discloses an apparatus that is designed for liquid dispersal or dry material using a hand held leaf blower as a source of air flow. However, this invention does not take advantage of the low pressure area created by the nozzle of the present invention to assist in particulate feed into the air stream. U.S. Pat. No. 5,964,420 to Hampton (1998) discloses a device for attachment for a leaf blower for applying powdered pesticides to a lawn or garden but is not well suited for dispersal of larger particulates or seeds. U.S. Pat. No. 5,779,161 to Dvorak (1998) discloses an apparatus for dispensing powdered and granulated materials and cites a conventional leaf blower as a motive source, but is unclear on how a leaf blower might be attached. U.S. Pat. No. 5,392,996 to Ussery (1994) discloses an apparatus that attaches to the intake of a leaf blower for introducing particulates into the air intake for dispersion through the outlet. Although this method would work, it would probably damage the leaf blower since the intake air is also used to cool the engine. The particulates would no doubt adhere to the cooling fins of the engine, causing it to overheat in a short time. U.S. Pat. No. 4,474,327 to Mattson et al. (1984) discloses a spreader attachment for leaf blowers. The disclosed method of entraining particulate material within the discharge air stream of a blower appears to be susceptible to clogging and other interference. It also appears to be a complicated apparatus to fabricate. U.S. Pat. No. 5,190,225 to Williams (1993) discloses a device for the dispersal of particulates, but lacks the simplicity of the present invention. U.S. Pat. No. 3,586,238 to Schmierer et. al. (1971) is similar to the apparatus described by U.S. Pat. No. 5,190,225 but seems more suited to dispensing nutrients and fertilizers and pesticides entrained in a liquid medium. It use appears to be limited to this use and would be costly to manufacture for this singular use. U.S. Pat. No. 5,429,278 to Sansalone (1994) discloses an apparatus specifically designed for fine particulates such as pesticides, and does not appear to have the capacity to accommodate large granular nutrients or seeds. U.S. Pat. No. 4,658,778 to Gamoh, et al. (1987) discloses a powered backpack unit designed to dispense fine particulates. This invention suffers from the same design flaw as Ussery, in that the particulate is introduced in the air supply which also cools the engine. U.S. Pat. No. 4,256,241 to Mesic (1981) discloses a device for the application of pesticide dust. This unit does not appear to be able to dispense large granular nutrients or seed due to this design. The material container is only suitable for a small amount of fine particulate material that could be distributed as a fine dust over many plants or a large grassy area to be treated for an infestation. U.S. Pat. No. 5,226,567 to Sansalone (1993) discloses an air-powered device for applying dust to garden plants. The device is limited in the capacity of the material container to powdered insecticides, and would not be able to dispense large granular nutrients due to the possibility of clogging of the delivery mechanism. U.S. Pat. No. 1,406,903 to Rose (1922) disclosed a hand held dry spray gun. This unit was not designed for fertilizer; it might be able to dispense seeds, but appears to be primarily designed for spraying dust.

### SUMMARY OF THE INVENTION

The present invention provides an apparatus that is easily attached to and removed from a hand-held leaf blower for the distribution, through the outlet air stream, of particulate matter including fertilizers, weed killers, pesticides and seed.

### BRIEF DESCRIPTION OF THE SEVERAL DRAWINGS

FIG. 1 is a view of the invention showing it mounted on the outlet tube of a leaf blower.

FIG. 2 is an exploded view of the invention.

FIG. 3 is an exploded view of the invention from the opposite perspective of FIG. 2.

FIG. 4 is an exploded view of the mounting mechanism of the invention.

FIG. 5 is an exploded view of the mounting mechanism of the invention from the opposite perspective of FIG. 4.

FIG. 6 is a view of the mounting mechanism of the invention fully assembled.

FIGS. 7 and 8 are views from the bottom side of the mounting mechanism showing the operation of the particulate flow limiting valve.

FIGS. 9 and 10 are view of the opposite halves of the hopper.

FIG. 11 is a detail view of the invention as attached to the outlet tube of a leaf blower.

FIG. 12 is a cut-away view of the invention as attached to the leaf blower.

FIG. 13 is a view of the attachment mechanism showing the operation of the flexible straps used to secure the attachment mechanism to the outlet tube of the leaf blower.

FIG. 14 is an expanded view of the ball-spring detent mechanism.

### DETAILED DESCRIPTION OF THE INVENTION

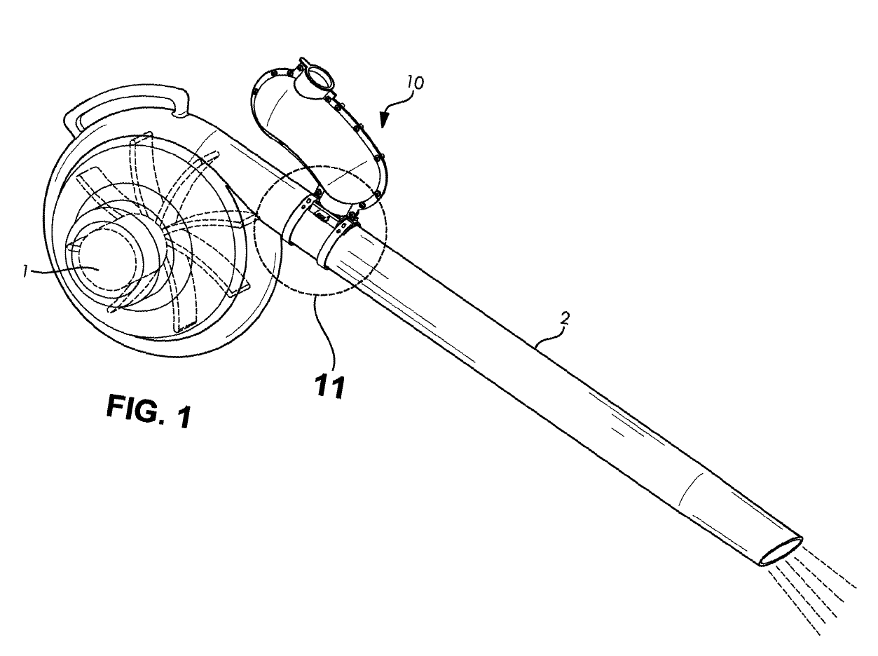

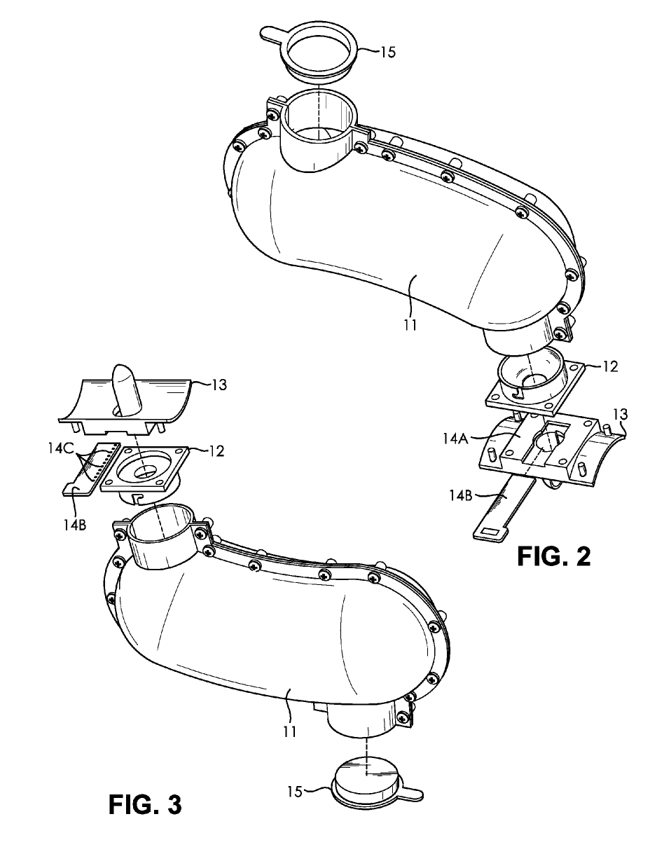

Referring to FIG. 1, the device 10 can be seen mounted on a portable, hand-held blower 1 having a motive force such as a gasoline or electric engine coupled with a fan that accepts air through an intake, accelerates the air and exhausts it at high speed through an outlet tube 2 having an inlet to accept the air from the blower 1 and an outlet. These types of blowers are in wide use with home owners and landscape professionals. Referring to FIG. 2, the invention 10 can be seen in exploded view comprising a hopper 11, a bayonet mount 12, and a saddle 13. The saddle 13 includes a regulating valve 14 which comprises raised boss 14a located on the top of the saddle 13 and a sliding plate 14b which fits into a slot provided in the boss 14a. In the preferred embodiment of the invention, the saddle 13 and the raised boss 14a are a single contiguous piece. Referring to FIG. 3, the underside of the invention 10 is illustrated. The underside of the plate 14b is provided with a plurality of depressions 14c which engage a ball-spring detent (not shown) in the saddle 13 to lock the plate into position when in use. A variety of means of keeping the plate 14b stationary could be used such as friction or a set screw, but the preferred embodiment uses a ball-spring detent. A cap 15 is also provided which prevents the contents of the hopper 11 from spilling when in use.

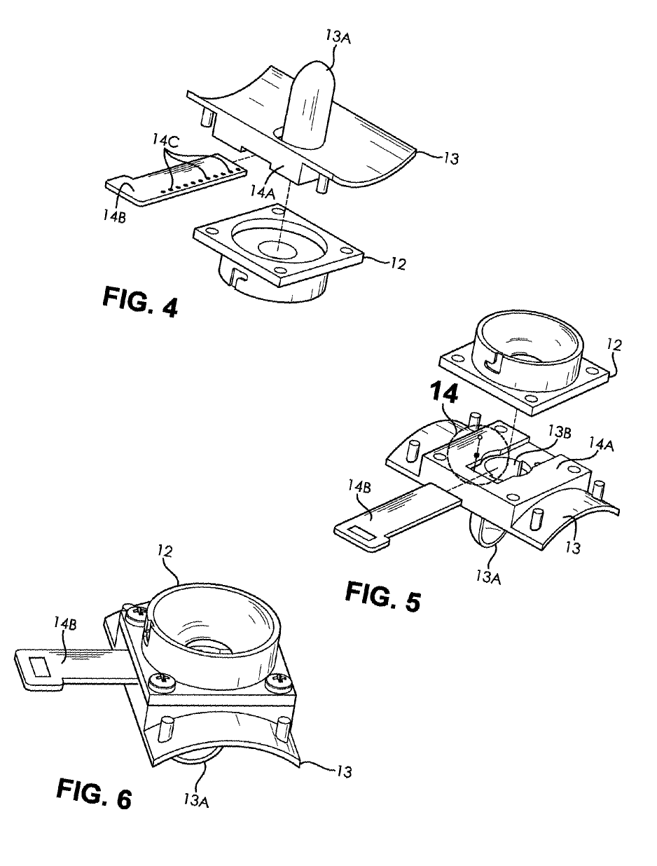

Referring to FIGS. 4, 5 and 6, the saddle 13, the bayonet mount 12 and the regulating valve 14 can be more clearly seen. FIG. 4 shows the underside of the saddle 13, allowing a view of a nozzle 13a which extends into the air flow provided by the blower. The nozzle 13a has a cylindrical profile facing the air stream and is open on the downstream side. As the air stream flows around the nozzle 13a, a relative low pressure region is created on the downstream side of the nozzle 13a. The low pressure assists in extracting the material from the hopper 11. The shape of the nozzle 13a ensures that a turbulent air flow is present on the downstream side. The turbulence created by the nozzle 13a mixes the material from the hopper 11 with the air stream, helping create a homogenous distribution of the material upon exiting the blower tube 2.

Referring to FIG. 5, it can be seen that the nozzle 13a is contiguous with a circular opening 13b through the saddle 13. Referring to FIG. 4, it can be seen that the bayonet mount 12 is also provided with a circular opening 12a therethrough, providing a path for the material in the hopper 11 to flow into the air stream provided by the blower. FIGS. 4 and 5 show the bayonet mount 12, the saddle 13 and sliding plate 14b in exploded view. FIG. 6 shows these parts assembled. In the preferred embodiment, screws are used to secure the bayonet mount 12 to the raised boss 14a. The saddle 13 and the raised boss 14a, in the preferred embodiment, are a single structure, formed by an injection molding process.

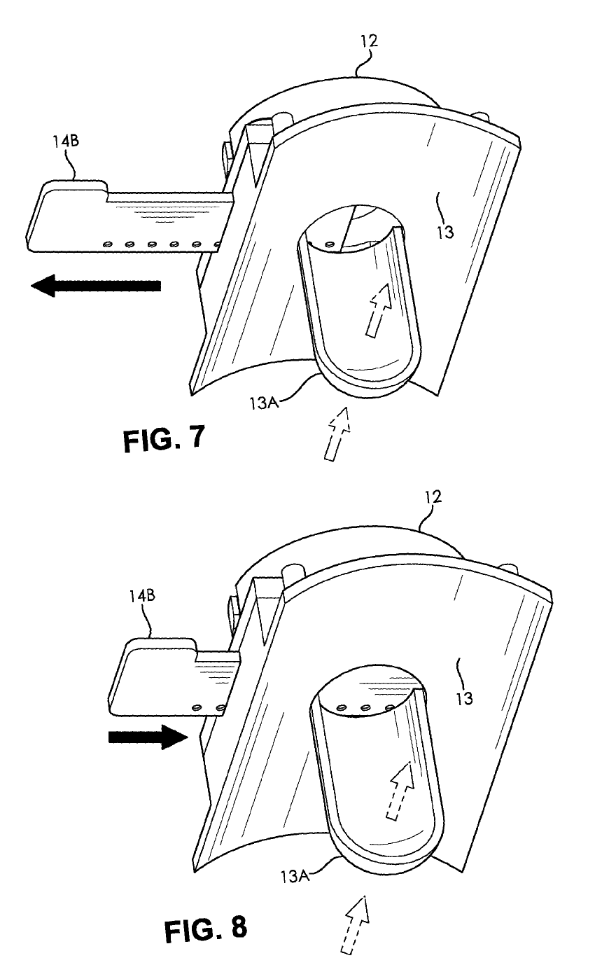

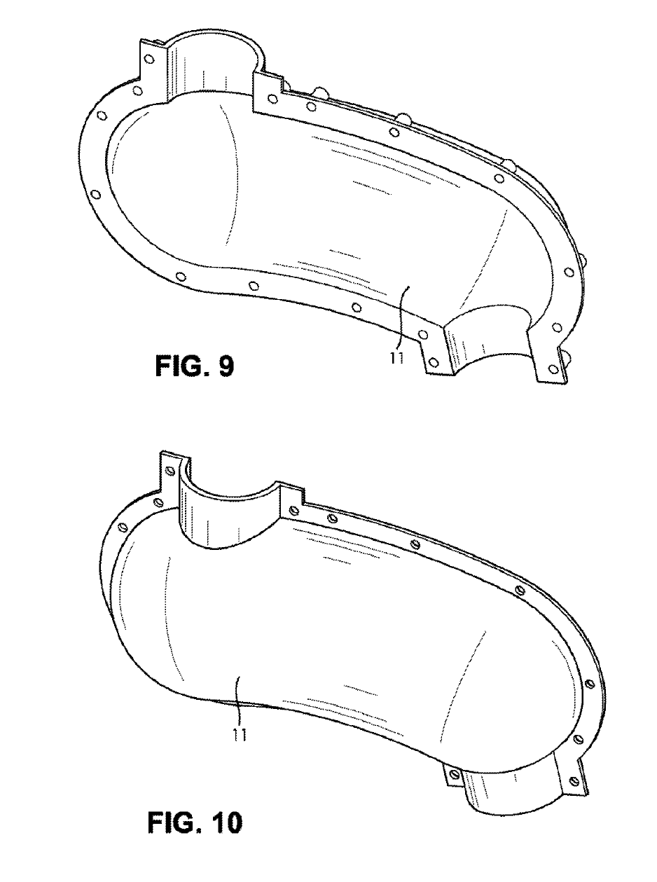

Referring to FIGS. 7 and 8, the configuration and operation of the regulating valve 14 can be seen. Referring to FIG. 7, the sliding plate 14a is show in on open position allowing the material from the hopper 12 to enter the air stream (shown by the arrows). FIG. 8 shows the regulating valve 14 in a closed position.

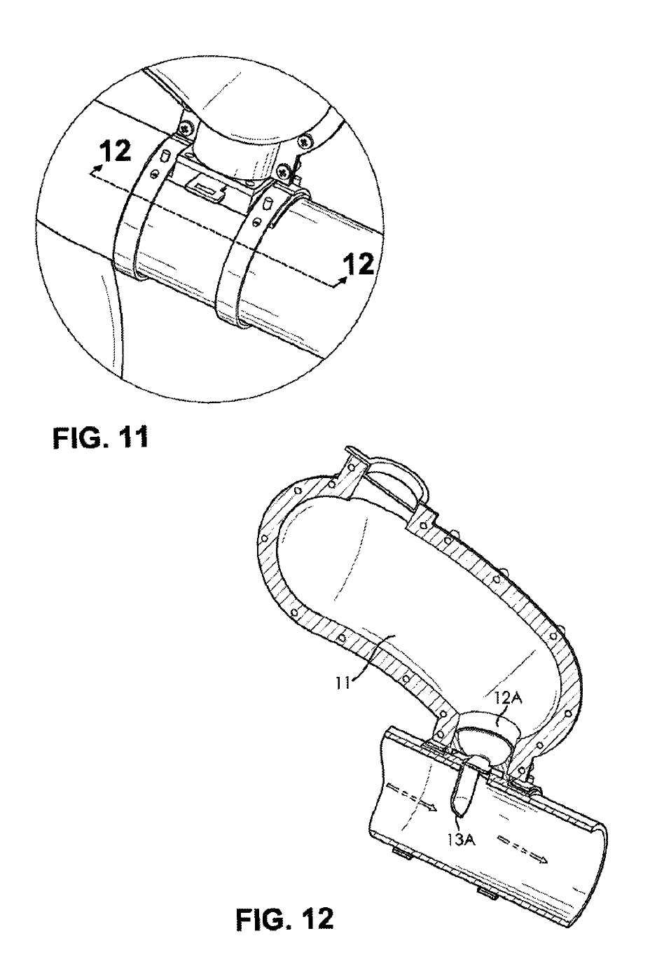

Referring to FIG. 11, the device 10 is shown attached to the outlet tube 2. FIG. 12 shows a cut-away view of the device 10 attached to the outlet tube 2. The nozzle 13 is shown extending into the air stream inside the outlet tube 2. Referring again to FIG. 12, it can be seen that the bayonet mount 12 is provided with a funnel shaped interior surface 12a to facilitate flow of the material from the hopper 11.

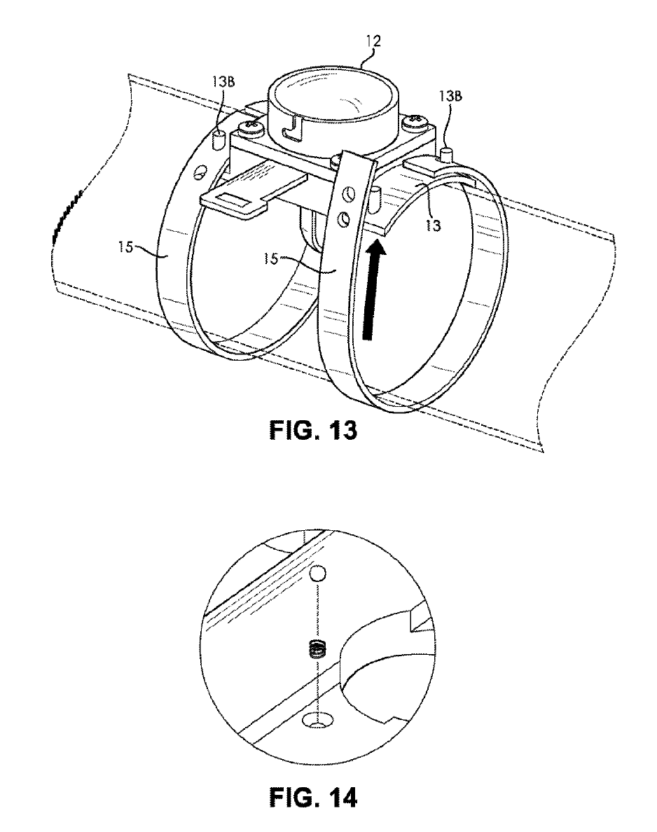

Referring to FIG. 13, the means of attachment of the device 10 to the outlet tube 2 is shown. The saddle 13 is provided with upwardly extending pegs 13a in each corner of the saddle 13. Flexible rubber straps 15 provided with a plurality of through holes are wrapped around the outlet tube 2 and fitted over the pegs 13a to secure the saddle 13 to the outlet tube 2. The hopper 11 is then attached to the bayonet mount 12.

The invention having been completely described, what is claimed is:

1. An apparatus for distributing dry, granular materials comprising:
a portable blower for creating an accelerated airflow having an air intake, a motor coupled to a fan for accelerating the airflow, and an outlet for exhausting the accelerated airflow;
an elongated outlet tube having an inlet in fluid communication with and connected to the outlet of said blower through which said airflow is delivered, said tube having an exit end through which said accelerated airflow exits;
a hopper carried by said tube for feeding an amount of dry, granular material to said tube, said hopper comprising an inlet for receiving said material, and an outlet for delivering said material to said tube;
said tube having an opening for receiving said dry material from said hopper and introducing said material into said airflow so that said dry material is mixed with said airflow passing through said outlet tube; and
a nozzle in fluid communication with said opening for receiving said dry material from said opening and dispersing it into said airstream, said nozzle extending from said opening into said airstream.

2. The apparatus of claim 10 including an adjustable valve for metering said amount of the dry material received from said hopper, said valve being disposed between said hopper and said outlet tube.

3. The apparatus of claim 11 wherein said adjustable valve comprises:
an adjustable valve element to provide a desired metering opening.

4. The apparatus of claim 12 wherein said adjustable valve element comprises a sliding plate.

5. The apparatus of claim 10 including a bayonet coupling for removably attaching said hopper to said outlet tube including:
a saddle carried by said outlet tube having an outwardly extending portion forming a male portion of a bayonet coupling, an inwardly extending portion forming said nozzle extending into said outlet tube through said opening of said outlet tube, said saddle, nozzle and outwardly extending portion having openings therethrough in fluid communication with each other; and
said outlet of said hopper forming a female portion of a bayonet coupling allowing fluid communication between said hopper and said nozzle.

6. The apparatus of claim 14 wherein said nozzle includes an upstream side with a semi-circular profile and a downstream side open to said airstream.

7. The apparatus of claim 14 wherein said saddle includes a solid sliding plate disposed between said upwardly extending portion and said inwardly extending portion so that said sliding plate may be moved to various positions relative to said opening to vary the opening and said amount of dry material distributed therethrough.

8. The apparatus of claim 16 wherein a lower side of said solid sliding plate comprises a row of spherical depressions thereon and said saddle comprises a ball-spring detent mechanism situated to mate with said depressions preventing said plate from moving after being set in position.

9. The apparatus of claim 17 wherein said saddle comprises a plurality of upwardly extending pegs set at an outer periphery of said saddle, said pegs engaging a plurality of flexible elastic straps set around said outlet tube.
